(19) United States
(12) Patent Application Publication
(10) Pub. No.: US 2007/0026124 A1
(43) Pub. Date: Feb. 1, 2007

(54) Low-sediment acidic protein beverages

(76) Inventors: Ronnie Yuan, San Diego, CA (US); Michelle Kazmierski, San Diego, CA (US)

Correspondence Address: J M HUBER CORPORATION, 333 THORNALL STREET, PATENT DEPARTMENT, EDISON, NJ, 08837-2220, US

(21) Appl. No.: 11/194,810

(22) Filed: Aug. 1, 2005

(51) Int. Cl. A23L 2/00

(52) U.S. Cl. 426/590

(57) ABSTRACT

Specific types of low pH protein-based beverages (such as soy- and/or dairy-based types) that are properly suspended to prevent undesirable sedimentation of such protein constituents during storage are provided. Such beverages include a thickening system comprising bacterial cellulose (BC) coated with different water soluble co-agents such that the BC-based component provides a network forming structure that suspends the target proteins and prevents any appreciable sedimentation of such proteins. Additionally, this system is capable of improving the suspension of acidic protein beverages fortified with insoluble calcium. The beverages encompassed within this invention exhibit certain stability benefits under typical storage conditions and may, depending upon the pH of the overall system, include additives that coat the proteins to prevent, or at least retard, aggregation of such constituent proteins when the pH level approaches their pertinent isoelectric point.

### FIELD OF THE INVENTION

The present invention relates generally to specific types of low pH protein-based beverages (such as soy- and/or dairy-based types) that are properly suspended to prevent undesirable sedimentation of such protein constituents during storage. Such beverages include a thickening system comprising bacterial cellulose (BC) coated with different water soluble co-agents such that the BC-based component provides a network forming structure that suspends the target proteins and prevents any appreciable sedimentation of such proteins. Additionally, this system is capable of improving the suspension of acidic protein beverages fortified with insoluble calcium. The beverages encompassed within this invention exhibit certain stability benefits under typical storage conditions and may, depending upon the pH of the overall system, include additives that coat the proteins to prevent, or at least retard, aggregation of such constituent proteins when the pH level approaches their pertinent isoelectric point.

### BACKGROUND OF THE INVENTION

Soy- and dairy-based protein beverages have increased in popularity as the availability of such products increases and improvements in organoleptic properties for such beverages occur. Currently, however, there are certain limitations present for widespread acceptance to consumers, primarily in terms of flavor and other aesthetic characteristics. A consumer is generally very particular about the beverage he or she ingests. As the populace becomes more health-conscious, such protein-based types have grown in acceptance. However, with such increased utilization comes the desire to increase options in terms of taste, scent, and appearance in order to provide a more attractive product. Such an ultimate goal has proven rather difficult to attain, mainly due to shelf-life stability problems associated with the nutrient base-product proteins present within such beverages.

Dairy milk has been consumed for a very long time and is a staple product after pasteurization. There is a continued desire, however, to provide different flavorings within such a product such that pH issues remain a recurring problem with the all-important proteins present therein. Soy milk has found a foothold within certain markets particularly due to the absence of lactose within such products. Such soy products, however, exhibit similar problems as with the dairy protein-based compositions in terms of long-term shelf stability.

With either dairy or soy milks that possess a neutral or close to neutral pH, the proteins within such a target beverage can be easily suspended with typical thickening agents (such as carboxymethylcellulose and other cellulose ethers, pectin, starch, xanthan gum, guar gum, locust bean gum, carrageenan and the like). At such neutral pH levels, soy or milk proteins have a net negative charge, thereby reliably keeping the protein particles from aggregating, clustering, or otherwise creating large particles. These typical thickening agents are believed to impart an increase to the viscosity of the water phase of the target beverage. This aiding in the retention of the water phase of such a target beverage thus potentially limits the formation of protein precipitate to the extent that the protein remains soluble therein. Thus, these typical thickening agents provide a manner of minimizing protein sedimentation at neutral pH levels.

The main problem exists when the pH level is lowered to a pH value of between about 3.6 and 4.5, in order to accommodate the addition of organoleptic enhancers, such as flavorings, colorants, and the like. Off-note, or beany flavors of soy milk may be masked, or flavor enhancements may be added to dairy milk, by changing the flavor and lowering the pH of these beverages, thus increasing the organoleptic and/or aesthetic characteristics of such a target beverage. This can cause the protein particles to exhibit a decrease in charge density (i.e., a pH at or near the isoelectric point for the particular proteins present therein). At such a specific pH level, such proteins are prone to thermal denaturation, leading to significant and highly undesirable aggregation or clustering of the protein molecules and resulting in the above-noted undesirable sedimentation from solution. Despite the efficacy that typical stabilizers, such as pectin, exhibit to minimize association of protein during acidification of low pH soy protein beverages, over time, sedimentation may still occur in the pH range of 3.6 to 4.5. Surface modifications and/or homogenization of the target proteins prior to pectin addition has been hypothesized as well in order to aid in permitting proper and sufficient coating by the pectin in solution and thus reduce the propensity of protein to protein interactions that cause the above-discussed sedimentation problems. Unfortunately, such a suggested improvement is quite expensive and difficult to practice, and thus is not likely to be readily followed in the soy beverage market.

There is thus a need to overcome this sedimentation problem within low pH protein-based beverages with a suspending aid that can meet the requirements of long-term storage stability. Even with thickening agents present, it has been realized that if the degree of aggregation of such proteins is sufficiently high, a suspension including such constituent nutrients is very difficult to retain. At acidic pH levels, in particular, certain proteins, particularly those within soy and/or dairy beverages, exhibit such undesirable aggregation and thus are highly susceptible to deleterious interactions between charged portions thereof. Certain typical thickening agents may be used as coating additives for the protein constituents in order to reduce or, at best, delay, such aggregation and ultimate sedimentation. For instance, pectin may be introduced within such a beverage composition which is then adjusted to an acidic pH levels (i.e., below 4.5). The pectin will become, in essence, activated at such an acidic level, such that it may not only properly coat such proteins, but will prevent, or, more appropriately, reduce protein-protein interactions near its isoelectric point. Importantly, though, is that pectin will not prevent such aggregation and ultimate sedimentation on a long-term basis; as such beverages generally require a very long shelf life, such a system of protein sedimentation reduction does not provide, by itself, effective results for the implementation of a low pH system to increase flavor levels (as one example) within soy protein beverages. Basically, and unfortunately, such sedimentation, as alluded to above, will invariably eventually aggregate over time even with pectin present as a coating additive. And, as a result, if sufficient sedimentation of protein particles does occur over time, such resultant sediment will pack or cement strongly and will not easily become released, even upon vigorous shaking. In such a scenario, the resultant sediment will not be ingested by the consumer, and thus the desired benefit from the desired protein will be lost.

Such pectin additives, however, do not provide the same type of significant, but limited, benefit when the pH is at a higher level (i.e., 5.0 to 6.0). At such a pH level, the pectin will not interact with the protein to the extent that proper coating and protection from such deleterious charged portion interactions will occur. At such a higher pH level, the proteins will not exhibit denaturation as readily as at a lower pH. The heat of processing, however, can still induce association and coagulation of proteins even though the subject formulation is present within this higher pH range (pH 5-6). With the pectin providing a certain degree of protection at lower pH levels, in essence the resultant interaction degree for the low pH pectin-only protected beverages will be quite similar to that as the higher pH level (i.e., 5.0) types, regardless of the presence of pectin. Thus, pectin alone will not provide a sufficient system of protection and thus protein sedimentation prevention within such acidic beverages, regardless of the actual pH level exhibited therein. Thus, a proper manner of not only potentially delaying such protein aggregation, but also providing a reliable long-term suspension system for such acidic protein-based beverages is of great necessity, particularly to increase the potential market for such products from an aesthetic perspective. To date, the best the market has been provided is the utilization of pectin alone as a coating additive, as noted above. An improvement in suspending systems, particularly with a solution that is low in cost and complexity and easy to incorporate within the beverage production methods, is thus highly desirable.

### SUMMARY OF THE INVENTION

Accordingly, this invention encompasses a liquid composition comprising at least one protein-based material and at least one bacterial cellulose-containing formulation comprising at least one bacterial cellulose material and at least one polymeric thickener selected from the group consisting of at least one charged cellulose ether, at least one precipitation agent selected from the group consisting of xanthan products, pectin, alginates, gellan gum, welan gum, diutan gum, rhamsan gum, carrageenan, guar gum, agar, gum arabic, gum ghatti, karaya gum, gum tragacanth, tamarind gum, locust bean gum, and the like, and any mixtures thereof, wherein said liquid composition exhibits a pH level of at most 5.5.

Furthermore, this invention also encompasses a liquid composition comprising at least one protein-based material in an amount of between 0.1 and 20% by weight and exhibiting a pH level of at most 5.5, wherein said liquid composition exhibits a sedimentation level of protein of at most 10% after 24 hours of storage at a temperature of 22° C. Additionally, this invention further encompasses liquid composition comprising at least one protein-based material in an amount of between 0.1 and 20% by weight, and a source of insoluble calcium in an amount of between 0.05 and 5% by weight, said liquid composition exhibiting a pH level of at most 5.5; wherein said liquid composition exhibits a sedimentation level of protein of at most 10% and a sedimentation level of insoluble calcium of at most 10% after 24 hours of storage at a temperature of 22° C.

The possible charged cellulose ether within the bacterial cellulose-containing formulation is a compound utilized to disperse and stabilize the reticulated network in the final end-use compositions to which such a bacterial cellulose-containing formulation is added. The charged compounds facilitate, as alluded to above, the ability to form the needed network of fibers through the repulsion of individual fibers. Such a network provides an excellent network within a target beverage that exhibits sufficient strength and stability upon long-term storage, as well as thixotropic characteristics, such that any aggregated proteins present within such a target beverage will not appreciably sediment over time. The possible precipitation agent within the bacterial cellulose-containing formulation is a compound utilized to preserve the functionality of the reticulated bacterial cellulose fiber during drying and milling. Examples of such charged cellulose ethers include such cellulose-based compounds that exhibit either an overall positive or negative and include, without limitation, any sodium carboxymethylcellulose (CMC), cationic hydroxyethylcellulose, and the like. The precipitation (drying) agent is selected from the group of natural and/or synthetic products including, without limitation, xanthan products, pectin, alginates, gellan gum, propylene glycol alginate, rhamsan gum, carrageenan, guar gum, agar, gum arabic, gum ghatti, karaya gum, gum tragacanth, tamarind gum, locust bean gum, and the like. Preferably, though not necessarily, a precipitation (drying) agent is included.

As one potentially preferred embodiment, the formulation of bacterial cellulose and pectin produced thereby has the distinct advantage of facilitating activation without any labor- or energy-intensive activation required. Another distinct advantage of this overall method is the ability to collect the resultant bacterial cellulose-containing formulation through precipitation with isopropyl alcohol, whether with a charged cellulose ether or a precipitation (drying) agent present therein. Thus, since the bacterial cellulose is co-precipitated in the manner described above, the alcohol-insoluble polymeric thickener (such as xanthan or sodium CMC) appears, without intending on being bound to any specific scientific theory, to provide protection to the bacterial cellulose by providing a coating over at least a portion of the resultant formed fibers thereof. In such a way, it appears that the polymeric thickener actually helps associate and dewater the cellulosic fibers upon the addition of a nonaqueous liquid (such as preferably a lower alkyl alcohol), thus resulting in the collection of substantial amounts of the low-yield polysaccharide during such a co-precipitation stage. The avoidance of substantial amounts of water during the purification and recovery steps thus permits larger amounts of the bacterial cellulose to be collected ultimately. With this novel process, the highest amount of fermented bacterial cellulose can be collected, thus providing the high efficiency in production desired, as well as the avoidance of, as noted above, wastewater and multiple passes of dewatering and re-slurrying typically required to obtain such a resultant product. Furthermore, as noted previously, the presence of a drying agent, in particular, as one non-limiting example, a pectin product, as a coating over at least a portion of the bacterial cellulose fiber bundles, appears to provide the improvement in activation requirements when introduced within a target end use composition. Surprisingly, there is a noticeable reduction in the energy necessary to effectuate the desired rheological modification benefits accorded by this inventive bacterial cellulose-containing formulation as compared with the previously practiced products of similar types. As well, since bacterial cellulose (hereinafter referred to as “BC”) provides unique functionality and rheology as compared to a soluble polymeric thickener alone, the resultant product made via this inventive method permits a lower cost alternative to typical processes with improvements in reactivation requirements, resistance to viscosity changes during high temperature food processing, and improved suspension properties during long term shelf storage.

Such target beverage are preferably dairy-based or soy-based and thus include protein substances associated directly with such materials. However, other types of beverages that include proteins that exhibit an aggregation capability may also be utilized within the scope of this invention. Such beverages include, without limitation, fruit flavored milk or soy milk drinks, nutritional beverages, and yogurt smoothie. Of particular interest are protein-including beverages that are desirous of proper suspension in order to provide nutrients in such a suspension form after long-term storage.

### DETAILED DESCRIPTION OF THE INVENTION

For purposes of this invention, the term “bacterial cellulose-containing formulation” is intended to encompass a bacterial cellulose product as produced by the inventive method and thus including a polymeric thickener coating at least a portion of the resultant bacterial cellulose fiber bundles. The term “formulation” thus is intended to convey that the product made therefrom is a combination of bacterial cellulose and a polymeric thickener produced in such a manner and exhibiting such a resultant structure and configuration. The term “bacterial cellulose” is intended to encompass any type of cellulose produced via fermentation of a bacteria of the genus Acetobacter and includes materials referred popularly as microfibrillated cellulose, reticulated bacterial cellulose, and the like.

Bacterial cellulose may be used as an effective rheological modifier in various compositions. Such materials, when dispersed in fluids, produce highly viscous, thixotropic mixtures possessing high yield stress. Yield stress is a measure of the force required to initiate flow in a gel-like system. It is indicative of the suspension ability of a fluid, as well as indicative of the ability of the fluid to remain in situ after application to a vertical surface.

Typically, such rheological modification behavior is provided through some degree of processing of a mixture of the bacterial cellulose in a hydrophilic solvent, such as water, polyols (e.g., ethylene glycol, glycerin, polyethylene glycol, etc.), or mixtures thereof. This processing is called “activation” and comprises, generally, high pressure homogenization and/or high shear mixing. The inventive bacterial cellulose-containing formulations of the invention, however, have been found to activate at low energy mixing. Activation is a process in which the 3-dimensional structure of the cellulose is modified such that the cellulose imparts functionality to the base solvent or solvent mixture in which the activation occurs, or to a composition to which the activated cellulose is added. Functionality includes providing such properties as thickening, imparting yield stress, heat stability, suspension properties, freeze-thaw stability, flow control, foam stabilization, coating and film formation, and the like. The processing that is followed during the activation process does significantly more than to just disperse the cellulose in base solvent. Such processing “tears apart” the cellulose fibers to expand the cellulose fibers. The bacterial cellulose-containing formulation may be used in the form of a wet slurry (dispersion) or as a dried product, produced by drying the dispersion using well-known drying techniques, such as spray-drying or freeze-drying to impart the desired rheological benefits to a target fluid composition. The activation of the bacterial cellulose BC expands the cellulose portion to create a reticulated network of highly intermeshed fibers with a very high surface area. The activated reticulated bacterial cellulose possesses an extremely high surface area that is thought to be at least 200-fold higher than conventional microcrystalline cellulose (i.e., cellulose provided by plant sources).

The bacterial cellulose utilized herein may be of any type associated with the fermentation product of Acetobacter genus microorganisms, and was previously available, as one example, from CPKelco U.S. under the tradename CELLULON®. Such aerobic cultured products are characterized by a highly reticulated, branching interconnected network of fibers that are insoluble in water.

The preparations of such bacterial cellulose products are well known. For example, U.S. Pat. No. 5,079,162 and U.S. Pat. No. 5,144,021, both of which are incorporated by reference herein, disclose a method and media for producing reticulated bacterial cellulose aerobically, under agitated culture conditions, using a bacterial strain of Acetobacter aceti var. xylinum. Use of agitated culture conditions results in sustained production, over an average of 70 hours, of at least 0.1 g/liter per hour of the desired cellulose. Wet cake reticulated cellulose, containing approximately 80-85% water, can be produced using the methods and conditions disclosed in the above-mentioned patents. Dry reticulated bacterial cellulose can be produced using drying techniques, such as spray-drying or freeze-drying, that are well known. Acetobacter is characteristically a gram-negative, rod shaped bacterium 0.6-0.8 microns by 1.0-4 microns. It is a strictly aerobic organism; that is, metabolism is respiratory, not fermentative. This bacterium is further distinguished by the ability to produce multiple poly β-1,4-glucan chains, chemically identical to cellulose. The microcellulose chains, or microfibrils, of reticulated bacterial cellulose are synthesized at the bacterial surface, at sites external to the cell membrane. These microfibrils generally have cross sectional dimensions of about 1.6 nm by 5.8 nm. In contrast, under static or standing culture conditions, the microfibrils at the bacterial surface combine to form a fibril generally having cross sectional dimensions of about 3.2 nm by 133 nm. The small cross sectional size of these Acetobacter-produced fibrils, together with the concomitantly large surface and the inherent hydrophilicity of cellulose, provides a cellulose product having an unusually high capacity for absorbing aqueous solutions. Additives have often been used in combination with the reticulated bacterial cellulose to aid in the formation of stable, viscous dispersions.

The aforementioned problems inherent with purifying and collecting such bacterial cellulose have led to the determination that the method employed herein provides excellent results to the desired extent. The first step in the overall process is providing any amount of the target bacterial cellulose in fermented form. The production method for this step is described above. The yield for such a product has proven to be very difficult to generate at consistently high levels, thus it is imperative that retention of the target product be accomplished in order to ultimately provide a collected product at lowest cost.

Purification is well known for such materials. Lysing of the bacterial cells from the bacterial cellulose product is accomplished through the introduction of a caustic, such as sodium hydroxide, or any like high pH (above about 12.5 pH, preferably) additive in an amount to properly remove as many expired bacterial cells as possible from the cellulosic product. This may be followed in more than one step if desired. Neutralizing with an acid is then typically followed. Any suitable acid of sufficiently low pH and molarity to combat (and thus effectively neutralize or reduce the pH level of the product as close to 7.0 as possible) may be utilized. Sulfuric acid, hydrochloric, and nitric acid are all suitable examples for such a step. One of ordinary skill in the art would easily determine the proper selection and amount of such a reactant for such a purpose. Alternatively, the cells may be lysed and digested through enzymatic methods (treatment with lysozyme and protease at the appropriate pH).

The lysed product is then subjected to mixing with a polymeric thickener in order to effectively coat the target fibers and bundles of the bacterial cellulose. The polymeric thickener must be insoluble in alcohol (in particular, isopropyl alcohol). Such a thickener is either an aid for dispersion of the bacterial cellulose within a target fluid composition, or an aid in drying the bacterial cellulose to remove water therefrom more easily, as well as potentially aid in dispersing or suspending the fibers within a target fluid composition. Proper dispersing aids (agents) include, without limitation, CMC (of various types), cationic HEC, etc., in essence any compound that is polymeric in nature and exhibits the necessary dispersion capabilities for the bacterial cellulose fibers when introduced within a target liquid solution. Preferably such a dispersing aid is CMC, such as CEKOL® available from CP Kelco. Proper precipitation aids (agents), as noted above, include any number of biogums, including xanthan products (such as KELTROL®, KELTROL T®, and the like from CP Kelco), gellan gum, welan gum, diutan gum, rhamsan gum, guar, locust bean gum, and the like, and other types of natural polymeric thickeners, such as pectin, as one non-limiting example. Basically, the commingling of the two products in broth, powder or rehydrated powder form, allows for the desired generation of the polymeric thickener coating on at least a portion of the fibers and/or bundles of the bacterial cellulose. In one embodiment, the broths of bacterial cellulose and xanthan are mixed subsequent to purification (lysing) of both in order to remove the residual bacterial cells. In another embodiment, the broths may be mixed together without lysing initially, but co-lysed during mixing for such purification to occur.

The amounts of each component within the method may vary greatly. For example, the bacterial cellulose will typically be present in an amount from about 0.1% to about 5% by weight, preferably from about 0.5 to about 3.0%, whereas the polymeric thickener may be present in an amount form 10 to about 900% by weight of the bacterial cellulose.

After mixing and coating of the bacterial cellulose by the polymeric thickener, the resultant product is then collected through co-precipitation in a water-miscible nonaqueous liquid. Preferably, for toxicity, availability, and cost reasons, such a liquid is an alcohol, such as, as most preferred, isopropyl alcohol. Other types of alcohols, such as ethanol, methanol, butanol, and the like, may be utilized as well, not to mention other water-miscible nonaqeuous liquids, such as acetone, ethyl acetate, and any mixtures thereof. Any mixtures of such nonaqueous liquids may be utilized, too, for such a co-precipitation step. Generally, the co-precipitated product is processed through a solid-liquid separation apparatus, allowing for the alcohol-soluble components to be removed, leaving the desired bacterial cellulose-containing formulation thereon.

From there, a wetcake form product is collected and then transferred to a drying apparatus and subsequently milled for proper particle size production. Further co-agents may be added prior to precipitation or to the wetcake or to the dried materials in order to provide further properties and/or benefits. Such co-agents include plant, algal and bacterial polysaccharides and their derivatives along with lower molecular weight carbohydrates such as sucrose, glucose, maltodextrin, and the like. Other additives that may be present within the bacterial cellulose-containing formulation include, without limitation, a hydrocolloid, polyacrylamides (and homologues), polyacrylic acids (and homologues), polyethylene glycol, poly(ethylene oxide), polyvinyl alcohol, polyvinylpyrrolidones, starch (and like sugar-based molecules), modified starch, animal-derived gelatin, dairy proteins, soy proteins, other animal or plant-derived proteins and non-charged cellulose ethers (such as carboxymethylcellulose, hydroxyethylcellulose, and the like).

The bacterial cellulose-containing formulations of this invention may then be introduced into the target inventive sufficiently low pH protein-based beverages. Such beverage compositions may include such bacterial cellulose-containing formulations in an amount from about 0.01% to about 1% by weight, and preferably about 0.03% to about 0.5% by weight of the total weight of the beverage composition and a protein-based material (preferably, though not necessarily dairy and or soy in nature) in an amount of from 0.1 to 20% by total weight of the beverage composition. Such protein-based materials include, again, without limitation, cow's milk, goat's milk, soy milk, milk solids, whey proteins, caseins, soy protein concentrate, soy protein isolate, and any mixtures thereof. Other possible additives that may be included within this low pH beverage include, particularly, flavorings, preservatives, colorants, stabilizers, sweeteners (such as sugar, saccharin, and the like), fruit pulps, dietary fibers, vitamins and minerals.

### PREFERRED EMBODIMENTS OF THE INVENTION

The following non-limiting examples provide teachings of various inventive beverages that are encompassed within this invention as well as comparatives examples.

Suspension Aid Production

### Example 1

BC was produced in a 1200 gal fermentor with final yield of 1.93 wt %. The broth was treated with 350 ppm of hypochlorite and subsequently treated with 70 ppm of lysozyme and 194 ppm of protease. A portion of the treated BC broth was mixed with a given amount of xanthan gum broth and CMC solution (BC/XG/CMC=3/1/1, dry basis) and the resultant mixture was then precipitated with IPA (85%) to form a press cake. The press cake was then dried and milled as in Example 1. The powdered formulation was then introduced into a STW sample in an amount of about 0.36% by weight thereof, and the composition was then mixed with a Silverson mixer at 8000 rpm for 5 min. The product viscosity and yield stress were 1057 cP and 3.65 dynes/cm², respectively.

### Example 2

BC was produced in a 1200 gal fermentor with final yield of 1.93 wt %. The broth was treated with 350 ppm of hypochlorite and subsequently treated with 70 ppm of lysozyme and 194 ppm of protease. A portion of the treated BC broth was mixed with a given amount of pectin solution (BC/Pectin=6/1, dry basis) and the resultant mixture was then precipitated with IPA (85%) to form a press cake. The press cake was dried and milled as in Example 1. The powdered formulation was then introduced into a STW sample in an amount of about 0.36% by weight thereof, with 20% CMC added simultaneously, and the composition was then mixed with a Silverson mixer at 8000 rpm for 5 min. The product viscosity and yield stress were 377 cP and 1.06 dynes/cm², respectively.

### Example 3

BC was produced in a 1200 gal fermentor with final yield of 1.93 wt %. The broth was treated with 350 ppm of hypochlorite and subsequently treated with 70 ppm of lysozyme and 194 ppm of protease. A portion of the treated BC broth was mixed with a given amount of CMC solution (BC/CMC=3/1, dry basis) and the resultant mixture was then precipitated with IPA (85%) to form a press cake. The press cake was dried and milled as in Example 1. The powdered formulation was then introduced into a STW sample in an amount of about 0.36% by weight thereof, and the composition was then mixed with a Silverson mixer at 8000 rpm for 5 min. The product viscosity and yield stress were 432 cP and 1.39 dynes/cm², respectively.

### Example 4

BC was produced in a 1200 gal fermentor with final yield of 1.93 wt %. The broth was treated with 350 ppm of hypochlorite and subsequently treated with 70 ppm of lysozyme and 194 ppm of protease. A portion of the treated BC broth was mixed with a given amount of pectin and CMC solutions (BC/Pectin/CMC=6/1/2, dry basis) and the resultant mixture was then precipitated with IPA (85%) to form a press cake. The press cake was dried and milled as in Example 1. The powdered formulation was then introduced into a STW sample in an amount of about 0.36% by weight thereof, and the composition was then mixed with a Silverson mixer at 8000 rpm for 5 min. The product viscosity and yield stress were 552 cP and 1.74 dynes/cm², respectively.

### Example 5

BC was produced in a 1200 gal fermentor with final yield of 1.4 wt %. The broth was treated with 350 ppm of hypochlorite and subsequently treated with 70 ppm of lysozyme and 350 ppm of protease followed with another 350 ppm of hypochlorite. A portion of the treated BC broth was mixed with a given amount of xanthan gum broth and pre-hydrated CMC solution (BC/XG/CMC=6/3/1, dry basis), then precipitated with IPA (85%), and dried and milled as in Example 1. The powdered formulation was then introduced into a STW solution and 0.25% CaCl₂ solution in an amount of about 0.2% by weight thereof, respectively, and the composition was then activated with an extensional homogenizer at 1500 psi for 2 passes. The product viscosities at 6 rpm were 343 cP and 334 cP in STW and 0.25% CaCl₂ solutions, respectively. About 20 3.2 mm diameter nylon beads (1.14 g/mL) were dropped into each of the solutions (in STW or 0.25% CaCl₂ solution) and the solutions were left at room temperature for 24 hrs. None of the beads settled down to the bottom of the beakers after the 24-hour time period.

### Example 6

BC was produced in a 1200 gal fermentor with final yield of 1.6 wt %. The broth was treated with 350 ppm of hypochlorite and subsequently treated with 70 ppm of lysozyme and 350 ppm of protease followed with another 350 ppm of hypochlorite. A portion of the treated BC broth was mixed with a given amount of pre-hydrated pectin and CMC solutions (BC/Pectin/CMC=6/3/1, dry basis), then precipitated with IPA (85%), and dried and milled as in Example 1. The powdered formulation was then introduced into a STW solution and 0.25% CaCl₂ solution in an amount of about 0.2% by weight thereof, respectively, and the composition was then activated with an extensional homogenizer at 1500 psi for 2 passes. The product viscosities at 6 rpm were 306 cP and 293 cP in STW and 0.25% CaCl₂ solutions, respectively. About 20 3.2 mm diameter nylon beads (1.14 g/mL) were dropped into each of the solutions (in STW or 0.25% CaCl₂ solution) and the solutions were left at room temperature for 24 hours. None of the beads settled down to the bottom of the beakers after the 24-hour time period.

### Example 7

BC was produced in a 1200 gal fermentor with final yield of 1.6 wt %. The broth was treated with 350 ppm of hypochlorite and subsequently treated with 70 ppm of lysozyme and 350 ppm of protease followed with another 350 ppm of hypochlorite. A portion of the treated BC broth was mixed with a given amount of pre-hydrated CMC solution (BC/CMC=3/1, dry basis), then precipitated with IPA (85%), and dried and milled as in Example 1. The powdered formulation was then introduced into a STW solution and 0.25% CaCl₂ solution in an amount of about 0.2% by weight thereof, respectively, and the composition was then activated with an extensional homogenizer at 1500 psi for 2 passes. The product viscosities at 6 rpm were 206 cP and 202 cP in STW and 0.25% CaCl₂ solutions, respectively. About 20 3.2 mm diameter nylon beads (1.14 g/mL) were dropped into each of the solutions (in STW or 0.25% CaCl₂ solution) and the solutions were left at room temperature for 24 hours. None of the beads settled down to the bottom of the beakers after the 24-hour time period.

Each sample exhibited excellent and highly desirable viscosity modification and yield stress results. In terms of bacterial cellulose products, such results have been heretofore unattainable with bacterial cellulose materials alone and/or with the low complexity methods followed herein.

Low pH Level Protein-Based Beverage Production and Analysis

Some initial comparative examples of pectin-containing soy-based beverages were produced initially in order to demonstrate the stability of acid soy drinks using such high methoxyl (HM) pectin alone. These formulations are presented in Table 1, below, with the processing conditions listed thereafter. The soy protein was an isolate available from Solae under the tradename XT34N IP.

TABLE 1

| | | | 0.20% Pectin | | 0.35% Pectin | | 0.50% Pectin | |
|---|---|---|---|---|---|---|---|---|
| | Control | | (Comp. Ex. 1) | | (Comp. Ex. 2) | | (Comp. Ex. 3) | |
| | Percent | Grams | Percent | Grams | Percent | Grams | Percent | Grams |
| 1.5% HM pectin solution | 0.00 | 0 | 13.33 | 666.7 | 23.33 | 1166.7 | 33.33 | 1666.7 |
| Deionized water | 65.39 | 3269.5 | 52.06 | 2602.8 | 42.06 | 2102.8 | 32.06 | 1602.8 |
| Soy protein isolate | 1.56 | 78 | 1.56 | 78.0 | 1.56 | 78.0 | 1.56 | 78.0 |
| Sugar | 8.00 | 400 | 8.00 | 400.0 | 8.00 | 400.0 | 8.00 | 400.0 |
| Orange juice | 25.00 | 1250 | 25.00 | 1250.0 | 25.00 | 1250.0 | 25.00 | 1250.0 |
| Sodium Citrate | 0.05 | 2.5 | 0.05 | 2.5 | 0.05 | 2.5 | 0.05 | 2.5 |

| | | | | |
|---|---|---|---|---|
| 50% citric acid solution | To pH 4.0 | To pH 4.0 | To pH 4.0 | To pH 4.0 |

The soy protein isolate was dispersed into 25° C. deionized (DI) water within a flask using a high speed mixer (Caframo Stirrer). The resultant mixture was then heated to 70° C., held for 5 min and then cooled to ambient temperature (about 20-25° C.). In a separate flask, the HM pectin was dispersed into 50° C. DI water using the same type of high speed mixer for 5 minutes and allowed to cool to ambient temperature. The HM pectin solution was then added to the soy isolate solution and stirred by hand for about 3 minutes until the temperature was about ˜25° C. The orange juice (no pulp MINUTE MAID® brand from The Coca-Cola Company) was then added to the resultant solution. Separately prepared was a dry blend of sodium citrate in the amounts noted in Table 1, above, the result of which was then introduced within the protein/pectin/juice solution. The pH was then adjusted to 4.0 using a 50% (w/v) citric acid solution while stirring. An ultrahigh temperature (UHT) process was then undertaken at 140.5° C. for a 4.5 second hold time, with further homogenization at 2000 psi (1500 first stage, 500 second stage), and ultimate cooling to 30° C. The samples were then aseptically introduced into polyethylene terephthalate copolyester Nalgene bottles at 30° C. for analysis. Such samples were then stored at room temperature for seven days and evaluated for stability and sedimentation.

Inventive samples were then prepared including certain bacterial-cellulose containing formulations, such as BC:Xanthan:CMC (stabilizer A from Example 1, above) and BC:Pectin:CMC (stabilizer B from Example 6, above). Table 2 shows the compositions made therefrom. The processes of preparing these are the same as outlined above.

TABLE 2

| | 0.1% | | 0.2% | | 0.1% | | 0.2% | |
|---|---|---|---|---|---|---|---|---|
| | Stabilizer A | | Stabilizer A | | Stabilizer B | | Stabilizer B | |
| | (Inv. Ex. 1) | | (Inv. Ex. 2) | | (Inv. Ex. 3) | | (Inv. Ex. 4) | |
| | Percent | Grams | Percent | Grams | Percent | Grams | Percent | Grams |
| Deionized Water | 65.29 | 3264.5 | 65.19 | 3259.5 | 65.29 | 3264.5 | 65.19 | 3259.5 |
| Soy protein isolate | 1.56 | 78 | 1.56 | 78 | 1.56 | 78 | 1.56 | 78 |
| Sugar | 8.00 | 400 | 8.00 | 400 | 8.00 | 400 | 8.00 | 400 |
| Orange juice | 25.00 | 1250 | 25.00 | 1250 | 25.00 | 1250 | 25.00 | 1250 |
| Sodium Citrate | 0.05 | 2.5 | 0.05 | 2.5 | 0.05 | 2.5 | 0.05 | 2.5 |
| Stabilizer | 0.10 | 5 | 0.20 | 10 | 0.10 | 5 | 0.20 | 10 |

| | | | | |
|---|---|---|---|---|
| 50% citric acid solution | to pH 4.0 | to pH 4.0 | to pH 4.0 | to pH 4.0 |

Each of the control, comparative examples, and inventive examples from Tables 1 and 2 were stored for seven days at room temperature and evaluated. The negative control completely phase separated with a 50% clear upper layer and a thick lower layer of sediment at the bottom half of the container. Upon adding 0.20% pectin, the beverage still formed a dense sediment at the bottom, with a cloudy upper layer that constituted 90% of the beverage, indicating there was an insufficient amount of pectin coating the protein during the acidification step. The 0.35% and 0.50% pectin samples were also unstable due to the development of a visible pellet at the bottom of the container, however the mouthfeel of these beverages were different. The control and 0.20% pectin sample had an objectionable grainy texture, while 0.35% and 0.50% pectin samples were smooth, despite their instability.

Beverages produced with the Inventive BC-based stabilizer 14 demonstrated noticeable improvements in stability over the pectin stabilized acid soy drinks. Stabilizer A showed improved stability over the control, with only 35% phase separation at 0.10% use level, compared to 50% phase separation in the control. The phase separation was further reduced to only 20% by increasing the concentration of Stabilizer A to 0.20%. Beverages stabilized with stabilizer B showed no signs of phase separation. The sensory attributes of these BC-based only beverages were grainy in texture. The results for these beverage examples are provided in the following Table 3:

TABLE 3

| | | 0.2% | 0.35% | 0.50% | 0.1% | 0.2% | 0.1% | 0.2% |
|---|---|---|---|---|---|---|---|---|
| | Control | Pectin | Pectin | Pectin | Stabilizer A | Stabilizer A | Stabilizer B | Stabilizer B |
| % Phase | 50 | 90 | 90 | 90 | 35 | 20 | 0 | 0 |
| Separation | | | | | | | | |
| Visual | Clear upper | Cloudy | Cloudy | Cloudy | Clear upper | Clear upper | Stable | Stable |
| Observations | layer | upper layer, | upper layer, | upper layer, | layer | layer | | |
| | | dense | dense | dense | | | | |
| | | sediment | sediment | sediment | | | | |
| Mouthfeel | Grainy | Grainy | Smooth | Smooth | Grainy | Grainy | Grainy | Grainy |
| Texture | | | | | | | | |

Further formulations were then prepared including both the inventive stabilizers and HM pectin in order to both improve the stability of the pectin only formulation and overcome the adverse texture of the BC-based stabilizer only formulation. These new inventive formulations were processed as follows and in accordance with the process steps outlined above after Table 1.

TABLE 4

| | 0.05% Stabilizer | | 0.075% Stabilizer | | 0.10% Stabilizer | |
|---|---|---|---|---|---|---|
| | B + 0.20% | | B + 0.20% | | B + 0.20% | |
| | Pectin | | Pectin | | Pectin | |
| | (Inv. Ex. 5) | | (Inv. Ex. 6) | | (Inv. Ex. 7) | |
| | Percent | Grams | Percent | Grams | Percent | Grams |
| 1.5% HM pectin solution | 13.3333 | 666.667 | 13.3333 | 666.667 | 13.3333 | 666.667 |
| Deionized water | 52.0042 | 2600.208 | 51.9779 | 2598.896 | 51.9517 | 2597.583 |
| Soy protein isolate | 1.5600 | 78.000 | 1.5600 | 78.000 | 1.5600 | 78.000 |
| Sugar | 8.0000 | 400.000 | 8.0000 | 400.000 | 8.0000 | 400.000 |
| Orange juice | 25.0000 | 1250.000 | 25.0000 | 1250.000 | 25.0000 | 1250.000 |
| Stabilizer B | 0.0500 | 2.500 | 0.0750 | 3.750 | 0.1000 | 5.000 |
| Sodium Citrate | 0.0500 | 2.500 | 0.0500 | 2.500 | 0.0500 | 2.500 |

| | | | |
|---|---|---|---|
| 50% citric acid solution | to pH 4.0 | to pH 4.0 | to pH 4.0 |

TABLE 5

| | 0.05% Stabilizer | | 0.075% Stabilizer | | 0.10% Stabilizer | |
|---|---|---|---|---|---|---|
| | B + 0.35% | | B + 0.35% | | B + 0.35% | |
| | Pectin | | Pectin | | Pectin | |
| | (Inv. Ex. 8) | | (Inv. Ex. 9) | | (Inv. Ex. 10) | |
| | Percent | Grams | Percent | Grams | Percent | Grams |
| 1.5% HM pectin solution | 23.3333 | 1166.667 | 23.3333 | 1166.667 | 23.3333 | 1166.667 |
| Deionized water | 42.0042 | 2100.208 | 41.9779 | 2098.896 | 41.9517 | 2097.583 |
| Soy protein isolate | 1.5600 | 78.000 | 1.5600 | 78.000 | 1.5600 | 78.000 |
| Sugar | 8.0000 | 400.000 | 8.0000 | 400.000 | 8.0000 | 400.000 |
| Orange juice | 25.0000 | 1250.000 | 25.0000 | 1250.000 | 25.0000 | 1250.000 |
| Stabilizer B | 0.0500 | 2.500 | 0.0750 | 3.750 | 0.1000 | 5.000 |
| Sodium Citrate | 0.0500 | 2.500 | 0.0500 | 2.500 | 0.0500 | 2.500 |

| | | | |
|---|---|---|---|
| 50% citric acid solution | to pH 4.0 | to pH 4.0 | to pH 4.0 |

Visual inspection after seven days showed that each of these inventive combinations of stabilizer B with 0.20% pectin greatly improved the stability of the 0.20% pectin beverage without BC-based stabilizer. Upon combining 0.05% stabilizer B/0.20% pectin, phase separation decreased from 90% shown in the pectin only beverage, to just 40%. This reduction was further reduced to 25% phase separation by using 0.075% stabilizer B/0.20% pectin, while only 10% instability was observed in the 0.10% stabilizer B/0.20% pectin combined system. Mouthfeel of all samples was smooth, due to the presence of pectin.

Although not presented above in tabular form, combinations of 0.35% pectin with Stabilizer A also showed improvements in stability over the pectin only beverage. After seven days, the samples demonstrated 10% phase separation in both the 0.05% and 0.075% stabilizer B/0.35% pectin stabilized beverages. Complete stability was achieved with 0.10% stabilizer B/0.35% pectin. Additionally, sensory evaluation of these stable samples indicated a smooth mouthfeel that lacked graininess. These data suggest that 0.10% stabilizer B in combination with 0.35% provides the optimum stability and mouthfeel for this application. These results are presented below in Table 6.

TABLE 6

| | Inv. Ex. 5 | Inv. Ex. 6 | Inv. Ex. 7 | Inv. Ex. 8 | Inv. Ex. 9 | Inv. Ex. 10 |
|---|---|---|---|---|---|---|
| % Phase | 40 | 25 | 10 | 10 | 10 | 0 |
| Separation | | | | | | |
| Visual | Clear upper | Clear upper | Clear upper | Clear upper | Clear upper | Stable |
| Observations | layer | layer | layer | layer | layer | |
| Mouthfeel | Smooth | Smooth | Smooth | Smooth | Smooth | Smooth |
| Texture | | | | | | |

Of further interest with this inventive system is the ability to demonstrate the functionality of BC-based stabilizers in suspending insoluble calcium in an acidified protein-based (soy, in this example, as a non-limiting selection) beverage. Stabilizers B and C (BC:CMC) (Example 3, above) were added to suspend calcium when used in addition to 0.35% pectin. The formulations were prepared as follows and in accordance with the process set forth after Table 1, above.

TABLE 7

| | | | 0.10% | | 0.10% | |
|---|---|---|---|---|---|---|
| | | | Stabilizer | | Stabilizer | |
| | | | B + 0.35% | | C + 0.35% | |
| | | | Pectin | | Pectin | |
| | Control | | (Inv. Ex. 11) | | (Inv. Ex. 12) | |
| | Percent | Grams | Percent | Grams | Percent | Grams |
| 1.5% HM pectin solution | 23.33 | 1166.5 | 23.33 | 1166.50 | 23.33 | 1166.50 |
| Deionized water | 41.74 | 2087.0 | 41.64 | 2082.00 | 41.64 | 2082.00 |
| Soy protein isolate | 1.56 | 78.0 | 1.56 | 78.00 | 1.56 | 78.00 |
| Sugar | 8.00 | 400.0 | 8.00 | 400.00 | 8.00 | 400.00 |
| Orange juice | 25.00 | 1250.0 | 25.00 | 1250.00 | 25.00 | 1250.00 |
| Tricalcium Phosphate | 0.32 | 16.0 | 0.32 | 16.00 | 0.32 | 16.00 |
| Stabilizer | 0.00 | 0.0 | 0.10 | 5.00 | 0.10 | 5.00 |
| Sodium Citrate | 0.05 | 2.5 | 0.0500 | 2.500 | 0.0500 | 2.500 |

| | | | |
|---|---|---|---|
| 50% citric acid solution | to pH 4.0 | to pH 4.0 | to pH 4.0 |

After seven days of room temperature, the control sample had the worst stability, due to formation of large sediment. The composition of the middle and bottom portion of the beverage was analyzed for solids and calcium content, in the stable and unstable regions, respectively. There was a higher amount of solids at the bottom compared to the center of the sample (15.16% vs. 11.80%). These unstable solids contained 2.15% unstable calcium compared to 0.68% in the stable portion of the beverage, of which the difference in calcium and solids in the sediment was composed of protein and sugars.

Both types of BC based stabilizers improved calcium suspension over the control. The difference in solids between the center and bottom of the sample in stabilizers B and C was negligible, as was the difference in calcium concentration, suggesting that both BC-based stabilizers were capable of suspending protein in the acidified soy beverage. The results are tabulated below in Table 8.

TABLE 8

| | Location of | % Total | % Ca in | % Ca | |
|---|---|---|---|---|---|
| | Sample | solids | solids | in Bev. | % RDA |
| Control | Center | 11.80% | 0.677% | 0.080% | 19.00% |
| | Bottom | 15.16% | 2.155% | 0.327% | 77.76% |
| Inv. Ex. 11 | Center | 13.16% | 1.221% | 0.161% | 38.24% |
| | Bottom | 13.19% | 1.242% | 0.164% | 39.00% |
| Inv. Ex. 12 | Center | 13.13% | 1.229% | 0.161% | 38.41% |
| | Bottom | 13.18% | 1.302% | 0.172% | 40.85% |

Thus, the inventive stabilized beveraged exhibited excellent calcium stabilization and suspension versus the control even when in solution with potentially aggregating protein solids.

Further work was then undertaken to investigate the functionality of inventive BC-based stabilizers co-processed with pectin in stabilizing low acidity (pH 5) soy protein juice drinks. The formulations testing are listed below in Table 9.

TABLE 9

| | | | 0.075% | | 0.10% | | 0.15% | |
|---|---|---|---|---|---|---|---|---|
| | | | Stabilizer B | | Stabilizer B | | Stabilizer B | |
| | Control | | (Inv. Ex. 13) | | (Inv. Ex. 14) | | (Inv. Ex. 15) | |
| | Percent | Grams | Percent | Grams | Percent | Grams | Percent | Grams |
| Water | 32.60 | 1630.00 | 32.53 | 1626.25 | 32.50 | 1625.00 | 32.45 | 1622.50 |
| Soy Milk | 35.00 | 1750.0 | 35.00 | 1750.0 | 35.00 | 1750.0 | 35.00 | 1750.0 |
| Sugar | 8.00 | 400.0 | 8.00 | 400.0 | 8.00 | 400.0 | 8.00 | 400.0 |
| Orange Juice | 24.00 | 1200.0 | 24.00 | 1200.0 | 24.00 | 1200.0 | 24.00 | 1200.0 |
| Sodium Citrate | 0.20 | 10.0 | 0.20 | 10.0 | 0.20 | 10.0 | 0.20 | 10.0 |
| Stabilizer | 0.00 | 0.0 | 0.075 | 3.8 | 0.10 | 5.00 | 0.15 | 7.5 |
| Vanilla Extract | 0.20 | 10.0 | 0.20 | 10.0 | 0.20 | 10.0 | 0.20 | 10.0 |
| Citric Acid Solution | to pH 5.0 | to pH 5.0 | to pH 5.0 | to pH 5.0 | to pH 5.0 | to pH 5.0 | to pH 5.0 | to pH 5.0 |
| (50% w/v) | | | | | | | | |

These formulations were prepared as follows: The soy protein isolate was first dispersed into 25° C. DI-water using an high speed mixer in a flask. The solution was then heated to 70° C., held for 5 minutes at that temperature, and then cooled to ambient temperature. The juice was then added to the soy milk while stirring. Sodium citrate, sugar and the inventive stabilizer were then dry blended in the amounts as listed above and added to the already mixed soy solution. The pH was then adjusted to 5.0 using a 50% (w/v) citric acid solution while stirring. An UHT process was then undertaken at 140.5° C. for a 4.5 second hold time, with homogenization at 2000 psi (1500 first stage, 500 second stage) and subsequent cooling to 30° C. Bottles of polyethylene terephthalate copolyester Nalgene were then filled aseptically (as above) bottles at 30° C. for storage and evaluation.

After 7 days room temperature storage, the control sample formed a protein sediment at the bottom of the container, and demonstrated 80% phase separation. Upon adding 0.075% stabilizer B, stability improved to just 35% phase separation. Increasing the concentration to 0.10% further improved the stability to 10% phase separation. Complete stability was observed in the sample stabilized with 0.15% stabilizer B. In addition, all samples were orally evaluated and there was no graininess noted in any the samples. These data demonstrated that the BC based stabilizer is capable of suspending soy protein in the pH range near 5.0. The results are tabulated below in Table 10.

TABLE 10

| | Control | Inv. Ex. 13 | Inv. Ex. 14 | Inv. Ex. 15 |
|---|---|---|---|---|
| % Phase | 80 | 35 | 10 | 0 |
| Separation | | | | |
| Visual | Clear upper | Clear upper | Clear upper | Stable |
| Observations | layer | layer | layer | |
| Mouthfeel | Smooth | Smooth | Smooth | Smooth |
| Texture | | | | |

Furthermore, experiments were then undertaken to investigate the functionality of inventive BC-based stabilizers in suspending heat-denatured milk proteins within a lightly acidified dairy based juice beverage. Two concentrations of stabilizer B (BC:Pectin:CMC) (Example 6, above) were added to the beverage and compared to the control sample. The formulations processed for this analysis were prepared as follows in accordance with Table 11 and in the outline below.

TABLE 11

| | | 0.15% | 0.20% |
|---|---|---|---|
| | | Stabilizer B | Stabilizer B |
| | Control | (Inv. Ex. 16) | (Inv. Ex. 17) |
| | Percent | Percent | Percent |
| Deionized Water | 37.85 | 37.70 | 37.65 |
| 2.0% Milk | 30.00 | 30.00 | 30.00 |
| Sugar | 8.00 | 8.00 | 8.00 |
| Orange Juice | 24.00 | 24.00 | 24.00 |
| Vanilla Flavor | 0.15 | 0.15 | 0.15 |
| Citric Acid Solution | to pH 5.0 | to pH 5.0 | to pH 5.0 |
| (50% w/v) | | | |

To prepare these beverage, DI water, milk, sugar and vanilla and were mixed together using a high speed mixer. To this resultant mixture was slowly added orange juice, and the pH of the resultant composition was then adjusted to 5.0 using a 50% (w/v) citric acid solution while stirring. An UHT process at 140.5° C. for 4.5 seconds hold time was then undertaken, with homogenization at 2000 psi (1500 first stage, 500 second stage), and subsequent cooling to 30° C. As above, polyethylene terephthalate copolyester Nalgene bottles were then filled aseptically at 30° C. and stored at room temperature for evaluation.

After 7 days of such storage, the control sample had completely failed, forming a dense sediment at the bottom of the container. Both samples using stabilizer B had completely uniform suspension of proteins in the drink. Oral evaluation of the sample demonstrated a noticeable grainy texture in the control sample, while 0.15% Stabilizer B and 0.20% Stabilizer B were smoother. The mouthfeel increased in thickness as the concentration of stabilizer B increased from 0.15% to 0.20%.

Thus, in all instances, the inclusion of the suspension aid with BC imparted excellent low phase separation, stable visual appearance, and excellent mouthfeel, particularly as compared with the control and the other comparative suspension aid systems.

While the invention will be described and disclosed in connection with certain preferred embodiments and practices, it is in no way intended to limit the invention to those specific embodiments, rather it is intended to cover equivalent structures and all alternative embodiments and modifications as may be defined by the scope of the appended claims and equivalence thereto.

1. A liquid composition comprising at least one protein-based material in an amount of between 0.1 and 20% by weight and exhibiting a pH level of at most 5.5, wherein said liquid composition exhibits a sedimentation level of protein of at most 10% after 24 hours of storage at a temperature of 22° C.

2. The liquid composition of claim 1 wherein said protein-based material is selected from the group consisting of soy milk, dairy milk, and any mixtures thereof.

3. The liquid composition of claim 2 wherein said protein-based material is soy milk.

4. The liquid composition of claim 3 exhibiting a pH level of at most 4.5.

5. The liquid composition of claim 2 wherein said protein-based material is dairy milk.

6. A liquid composition comprising at least one protein-based material in an amount of between 0.1 and 20% by weight, and a source of insoluble calcium in an amount of between 0.05 and 5% by weight, said liquid composition exhibiting a pH level of at most 5.5; wherein said liquid composition exhibits a sedimentation level of protein of at most 10% and a sedimentation level of insoluble calcium of at most 10% after 24 hours of storage at a temperature of 22° C.

7. The liquid composition of claim 6 wherein said protein-based material is selected from the group consisting of soy milk, dairy milk, and any mixtures thereof and said insoluble calcium source is a material selected from the group consisting of tricalcium phosphate, calcium carbonate, and calcium citrate.

8. The liquid composition of claim 7 wherein said protein-based material is soy milk and said insoluble calcium source is tricalcium phosphate.

9. The liquid composition of claim 8 exhibiting a pH level of at most 4.5.

10. The liquid composition of claim 7 wherein said protein-based material is dairy milk.
